(19) United States
(12) Patent Application Publication
(10) Pub. No.: US 2012/0275017 A1
(43) Pub. Date: Nov. 1, 2012

(54) ENERGY CONSERVATION ASSEMBLY AND METHOD FOR USING THE SAME

(76) Inventor: Derrick J. McCarthy, Grand Rapids, MI (US)

(21) Appl. No.: 13/549,576

(22) Filed: Jul. 16, 2012

Related U.S. Application Data
(63) Continuation-in-part of application No. 13/086,105, filed on Apr. 13, 2011.
(60) Provisional application No. 61/364,240, filed on Jul. 14, 2010.
(60) Provisional application No. 61/323,616, filed on Apr. 13, 2010.

(51) Int. Cl. G02B 5/26

(52) U.S. Cl. 359/359

(57) ABSTRACT

An energy conservation assembly for use in a residential, commercial and/or industrial building including: a first substantially transparent substrate having an inner surface and an outer surface, wherein the first substantially transparent substrate is associated with the building; an energy conservation layer having an inner surface and an outer surface, wherein the energy conservation layer is associated with the first substantially transparent substrate; wherein the energy conservation layer substantially reflects both infrared and ultraviolet radiation away from the building thereby reducing cooling load of the building; and wherein the energy conservation layer permits substantial transmission of visible radiation into the building.

### CROSS-REFERENCE TO RELATED APPLICATIONS

This application is a continuation-in-part of U.S. application Ser. No. 13/086,105, filed Apr. 13, 2011, entitled “ENERGY REFLECTIVE DEVICE,” which claims the benefit of U.S. Provisional Application Ser. No. 61/364,240, filed Jul. 14, 2010, entitled “ENERGY REFLECTIVE DEVICE,” and U.S. Provisional Application Ser. No. 61/323,616, filed Apr. 13, 2010, entitled “ENERGY REFLECTIVE DEVICE,” all of which are hereby incorporated herein by reference in their entirety, including all references cited therein.

### BACKGROUND OF THE INVENTION

1. Field of the Invention

The present invention relates in general to energy conservation assemblies and, more particularly, to energy conserving assemblies for use in residential, commercial, and/or industrial applications which controllably reflect predetermined wavelengths of electromagnetic radiation, including infrared radiation (i.e., heat ranging in wavelength from approximately 750 nanometers (nm) to approximately 1 millimeter (mm)) and ultraviolet radiation (i.e., non-visible light ranging in wavelength from approximately 10 nm to approximately 400 nm), while controllably permitting the transmission of visible radiation (i.e., visible light ranging in wavelength from approximately 400 nm to approximately 750 nm).

2. Background Art

Electromagnetic radiation, which emanates primarily from the sun, can be both beneficial and problematic for residential, commercial, and/or industrial buildings, as well as their occupants and contents. For example, visible radiation is beneficial from an energy perspective because it provides light and, therefore, reduces and/or eliminates the need to utilize energy for interior lighting. However, infrared radiation, especially during summer months, can be problematic from an energy perspective because it heats the interior of buildings, sometimes excessively to the point where energy is required to cool the building to an acceptable temperature for both its occupants and associated contents—including, for example, computer hardware. Additionally, ultraviolet radiation can be problematic to the interior contents of residential, commercial, and/or industrial buildings (e.g., furniture, fabrics, décor, etcetera) because it discolors, fades and accelerates degradation of these contents.

It has now been surprisingly discovered that utilization of novel materials can controllably reflect certain wavelengths of electromagnetic radiation (e.g., ultraviolet, infrared, etcetera), while at the same time controllably permitting the transmission of other wavelengths of electromagnetic radiation (e.g., visible light) to conserve energy in both warm and cold weather environments.

It is therefore an object of the present invention, among other objects, to provide an energy conservation assembly for use in residential, commercial, and/or industrial applications that remedy the aforementioned problems associated with normal exposure to electromagnetic radiation emanating primarily from the sun.

These and other objects of the present invention will become apparent in light of the present specification, claims, and appended drawings.

### SUMMARY OF THE INVENTION

The present invention is preferably directed to an energy conservation assembly for use in a residential, commercial and/or industrial building comprising: (a) a first substantially transparent substrate having an inner surface and an outer surface, wherein the first substantially transparent substrate is associated with the building; (b) an energy conservation layer having an inner surface and an outer surface, wherein the energy conservation layer is associated with the first substantially transparent substrate; (c) wherein the energy conservation layer substantially reflects both infrared and ultraviolet radiation away from the building thereby reducing the cooling load of the building; and (d) wherein the energy conservation layer permits substantial transmission of visible radiation into the building.

In a preferred embodiment of the present invention, the energy conservation layer reflects at least approximately 75 percent of ultraviolet radiation emanating from the sun away from the building, and more preferably at least approximately 95 percent of ultraviolet radiation emanating from the sun away from the building, and yet more preferably at least approximately 99 percent of ultraviolet radiation emanating from the sun away from the building.

In another preferred embodiment of the present invention, the energy conservation layer reflects at least approximately 75 percent of infrared radiation emanating from the sun away from the building, and more preferably at least approximately 80 percent of infrared radiation emanating from the sun away from the building, and yet more preferably at least approximately 90 percent of infrared radiation emanating from the sun away from the building.

In yet another preferred embodiment, the energy conservation layer permits transmission of at least approximately 20 percent of visible radiation into the building, and more preferably at least approximately 30 percent of visible radiation into the building, and yet more preferably at least approximately 40 percent of visible radiation into the building.

In another aspect of the present invention, the energy conservation layer reflects less than approximately 30 percent of visible radiation emanating from the sun away from the building, and more preferably less than approximately 20 percent of visible radiation emanating from the sun away from the building.

In a preferred embodiment of the present invention the energy conservation assembly further comprises a protective topcoat layer associated with the energy conservation layer.

In another preferred embodiment of the present invention, the energy conservation layer is positioned on at least a portion of the outer surface of the first substantially transparent substrate. In this embodiment the protective topcoat is preferably positioned on at least a portion of the outer surface of the energy conservation layer.

The present invention is also preferably directed to an energy conservation assembly for use in a residential, commercial and/or industrial building, comprising: (a) a first substantially transparent substrate having an inner surface and an outer surface, wherein the first substantially transparent substrate is associated with the building; (b) an energy conservation layer having an inner surface and an outer surface, wherein the energy conservation layer is associated with the inner surface of the first substantially transparent substrate; (c) wherein the energy conservation layer substantially reflects both infrared and ultraviolet radiation into the building thereby reducing the heating load of the building; and (d) wherein the energy conservation layer permits substantial transmission of visible radiation into the building.

The present invention is additionally directed to an energy conservation assembly for use in a residential, commercial and/or industrial building consisting of: (a) a first substantially transparent window having an inner surface and an outer surface, wherein the first substantially transparent window is associated with the building; (b) an energy conservation layer having an inner surface and an outer surface, wherein the inner surface of the energy conservation layer is positioned on the outer surface of the first substantially transparent window substrate; (c) wherein the energy conservation layer substantially reflects both infrared and ultraviolet radiation away from the building thereby reducing the cooling load of the building; and (d) wherein the energy conservation layer permits substantial transmission of visible radiation into the building.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted. It will be further understood that the invention is not necessarily limited to the particular embodiments illustrated herein.

The invention will now be described with reference to the drawings wherein:

FIG. 1 of the drawings is a cross-sectional schematic representation of an energy conservation assembly fabricated in accordance with the present invention showing, among other things, a substantially transparent substrate associated with an energy conservation layer which reduces the cooling load of an associated building;

FIG. 2 of the drawings is a cross-sectional schematic representation of an energy conservation assembly fabricated in accordance with the present invention showing, among other things, an energy conservation layer secured to a substantially transparent substrate via reclosable fasteners;

FIG. 3 of the drawings is a cross-sectional schematic representation of an energy conservation assembly fabricated in accordance with the present invention showing, among other things, a substantially transparent substrate associated with an energy conservation layer, and a protective top-coat layer associated with the energy conservation layer;

FIG. 4 of the drawings is a cross-sectional schematic representation of an energy conservation assembly fabricated in accordance with the present invention showing, among other things, an energy conservation layer positioned between a pair of substantially transparent substrates;

FIG. 5 of the drawings is a cross-sectional schematic representation of an energy conservation assembly fabricated in accordance with the present invention showing, among other things, an insulated, energy conservation layer positioned between a pair of substantially transparent substrates;

FIG. 6 of the drawings is a cross-sectional schematic representation of an energy conservation assembly fabricated in accordance with the present invention showing, among other things, a substantially transparent substrate associated with an energy conservation layer which reduces the heating load of an associated building;

FIG. 7 of the drawings is a cross-sectional schematic representation of an energy conservation assembly fabricated in accordance with the present invention showing, among other things, a substantially transparent substrate associated with a pair of energy conservation layers which reduces the heating and cooling loads of an associated building; and

FIG. 8 of the drawings is a cross-sectional schematic representation of an energy conservation assembly fabricated in accordance with the present invention showing, among other things, a pair of substantially transparent substrates each of which are associated with an energy conservation layer which collectively reduce the heating and cooling load of an associated building.

### DETAILED DESCRIPTION OF THE INVENTION

While this invention is susceptible of embodiment in many different forms, there is shown in the drawings and described herein in detail several specific embodiments with the understanding that the present disclosure is to be considered as an exemplification of the principles of the invention and is not intended to limit the invention to the embodiments illustrated.

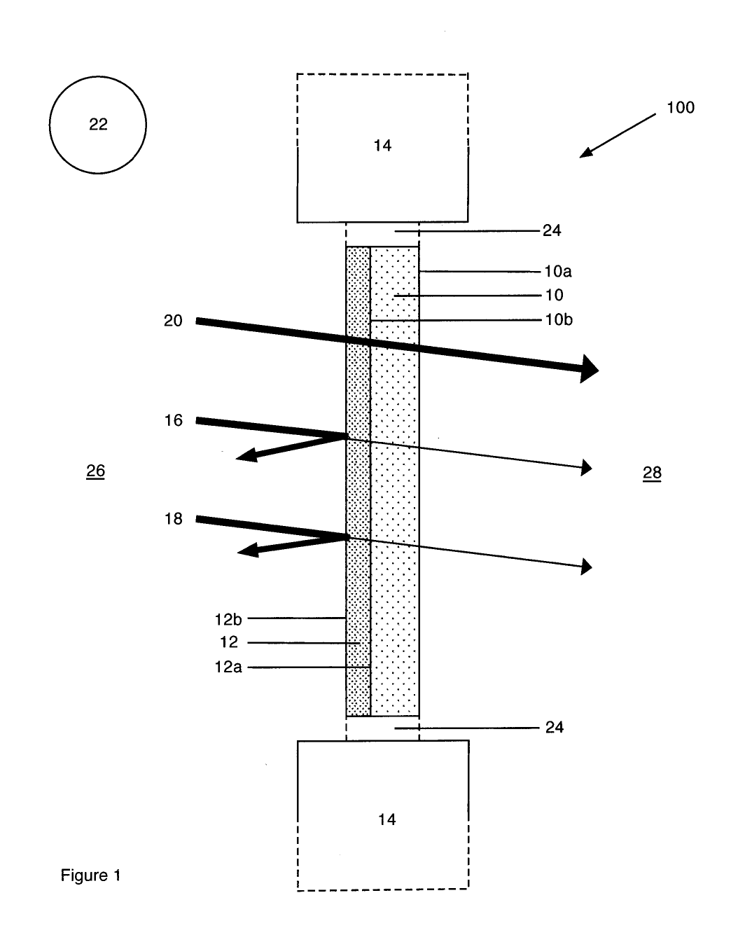

It will be understood that like or analogous elements and/or components, referred to herein, may be identified throughout the drawings with like reference characters. It will be further understood that FIGS. 1-8 are merely schematic representations of energy conservation assemblies. As such, some of the components have been distorted from their actual scale for pictorial clarity.

In accordance with the present invention, the energy conservation assemblies include windows, windowed doors, skylights, transparencies, etcetera for use in residential, commercial, and/or industrial buildings which permit substantial transmission of visible radiation into the building, and which substantially reflect both infrared and ultraviolet radiation away from the building and/or which substantially reflect both infrared and ultraviolet radiation into the building—depending on device configuration which is typically determined by geographical climate and/or season. It will be understood that regardless of its ordinary meaning the term “substantially” will be defined herein as a great or significant extent as appreciated by one having ordinary skill in the art.

Referring now to the drawings and to FIG. 1 in particular, a cross-sectional schematic representation of energy conservation assembly 100 is shown, which generally comprises first substrate 10 having inner surface 10a and outer surface 10b, and energy conservation layer 12 having inner surface 12a and outer surface 12b, which are associated with building 14. It will be understood that inner and outer surfaces referred to herein are relative to building 14. Preferably, inner surface 12a of energy conservation layer 12 is positioned on outer surface 10b of first substrate 10. However, in this embodiment, outer surface 12b of energy conservation layer 12 may also be positioned on inner surface 10a of first substrate 10 to achieve beneficial results discussed infra. As will be shown experimentally below, it has now been surprisingly discovered that energy conservation layer 12 substantially reflects infrared radiation 16 and ultraviolet radiation 18 away from building 14, thereby reducing the cooling load of building 14 while permitting substantial transmission of visible radiation 20 into building 14. It will be understood that electromagnetic radiation, including infrared, ultraviolet, and visible radiation emanates primarily from sun 22.

First substrate 10 may be fabricated from any one of a number of materials that are transparent or substantially transparent in the visible region of the electromagnetic spectrum, such as, for example, glass, borosilicate glass, soda lime glass, natural and synthetic polymeric resins, plastics, and/or composites including polyesters (e.g., PET), polyimides (PI), cellular polycarbonates, polycarbonates, polysulfones, polyethylene naphthalate (PEN), ethylene vinyl acetate (EVA), acrylate polymers, as well as Topas®, which is commercially available from Ticona of Summit, N.J. First substrate 10 is preferably fabricated from a sheet of glass having a thickness ranging from approximately 0.10 millimeters (mm) to approximately 50 mm, more preferably from approximately 0.50 mm to approximately 25 mm, and yet more preferably from approximately 0.75 mm to approximately 20 mm. Of course, the thickness of the substrate will depend largely upon the particular application of the window. While particular substrate materials have been disclosed, for illustrative purposes only, it will be understood that numerous other substrate materials are likewise contemplated for use—so long as the materials are at least substantially transparent and exhibit appropriate physical properties, such as strength, to be able to operate effectively in conditions of intended use. Indeed, substrates in accordance with the present invention can be, during normal operation, exposed to extreme temperature variation as well as impact force in residential, commercial, and/or industrial type buildings.

If first substrate 10 is fabricated from a sheet of glass, then the glass can optionally be tempered, heat strengthened, and/or chemically strengthened prior to or subsequent to being associated with energy conservation layer 12.

In accordance with the present invention, energy conservation layer 12 may comprise any material identified herein as suitable for use as first substrate 10 having an energy conservation layer or coating associated therewith and/or comprise an energy conservation coating which is associated with and/or applied to a substrate, such as first substrate 10. The energy conservation layer is fabricated from one or more materials that controllably reflect, absorb, and/or alter predetermined wavelengths of electromagnetic radiation, including infrared radiation and ultraviolet radiation, while controllably permitting the transmission of visible radiation. Energy conservation layer 12 may be incorporated into a solvent or a water borne coating that may be applied to at least a portion of first substrate 10. Preferably, energy conservation layer 12 comprises a material commercially available from Innovative Solutions, LLC, located in Lake Orion, Mich., sold under the trade name 3S Solar Block™. Energy conservation layer 12 is preferably associated with and/or applied to first substrate 10 by way of one or more processes such as dip coating, spin coating, spraying, laminating, filming or the like. While energy conservation layer 12 has been disclosed, for illustrative purposes only, as comprising a separate member than first substrate 10, it will be understood that energy conservation layer 12 may be partially or fully impregnated or otherwise incorporated into first substrate 10.

Energy conservation assembly 100 optionally includes sealing member 24 that is positioned between first substrate 10 and energy conservation layer 12, and building 14. Sealing member 24 may comprise a frame fabricated from metals, alloys, wood, plastics, composites, and combinations thereof, and/or any material that is capable of being sealingly and/or adhesively bonded to first substrate 10, energy conservation layer 12, and building 14 to, in turn, isolate building 14 into external and internal regions 26 and 28, respectively. As is shown in dashed lines in FIG. 1, it is also contemplated that first substrate 10 and energy conservation layer 12 extend all the way to building 14, thus eliminating the need for sealing member 24. In such an embodiment, first substrate 10 and energy conservation layer 12 are preferably friction fitted, pressure fitted, and/or conventionally secured to building 14. It will be understood that sealing member 24 can be fabricated from any one of a number of materials including, for example, adhesives, glues, sealants, an epoxy resin or mixture of resins (e.g., cycloaliphatic epoxy resins including, for example, Omnilane OC1005, which is available from IGM Resins Inc., Bartlett, Ill., aromatic epoxy resins including, for example, Bis-F, Bis-A, and/or epoxy novolac resins including, for example, DER 354, DER 332, and DEN 431, which are all available from the Dow Chemical Company—all of which may be optionally filled with fumed silica or other fillers such as glass beads, calcium carbonate, aluminum oxide, calcium fluoride, or other fillers as desired), as well as those disclosed in U.S. Pat. No. 4,297,401 entitled “Liquid Crystal Display And Photopolymerizable Sealant Therefor,” U.S. Pat. No. 4,418,102 entitled “Liquid Crystal Displays Having Improved Hermetic Seal,” U.S. Pat. No. 4,695,490 entitled “Seal For Liquid Crystal Display,” U.S. Pat. No. 5,596,023 entitled “Sealing Material For Liquid Crystal Display Panel, And Liquid Crystal Display Panel Using It,” and U.S. Pat. No. 5,596,024 entitled “Sealing Composition For Liquid Crystal,” all of which are hereby incorporated herein by reference in their entirety including all references incorporated and/or cited therein.

In accordance with the preset invention, and as will be shown experimentally below, energy conservation assembly 100 includes energy conservation layer 12 which preferably reflects at least approximately 75 percent, and more preferably at least approximately 95, and yet more preferably at least approximately 99 percent, and most preferably at least approximately 99.9 percent, of ultraviolet radiation 18 emanating from sun 22 away from building 14.

In further accordance with the present invention, energy conservation assembly 100 includes energy conservation layer 12 which preferably reflects at least approximately 75 percent, and more preferably at least approximately 80, and yet more preferably at least approximately 90 percent, of infrared radiation 16 emanating from sun 22 away from building 14.

Preferably, energy conservation layer 12 of the present invention permits transmission of at least approximately 20 percent, and more preferably at least approximately 30 percent, and yet more preferably at least approximately 40 percent, of visible radiation 20 into building 14.

Energy conservation layer 12 preferably reflects less than approximately 30 percent, and more preferably less than approximately 20 percent, of visible radiation 20 emanating from sun 22 away from building 14.

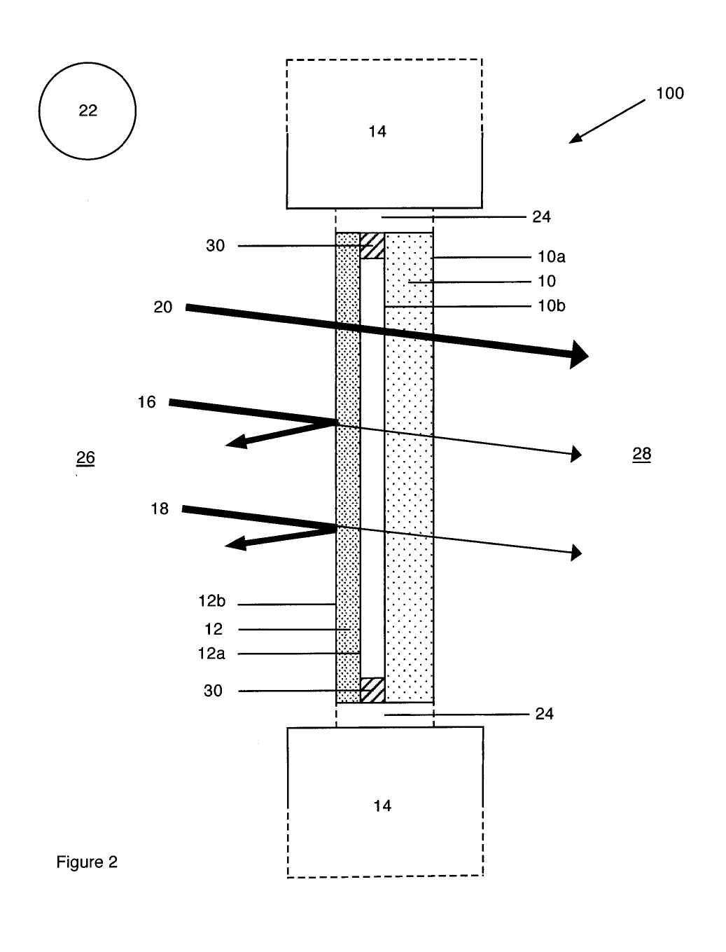

As is shown in FIG. 2, energy conservation assembly 100 may also comprise reclosable fasteners 30 which secure energy conservation layer 12 to first substrate 10. Reclosable fasteners 30 allow energy conservation layer 12 to be removed for cleaning and/or storage during months when electromagnetic radiation is non-problematic. Non-limiting examples of suitable reclosable fasteners for use in accordance with the present invention include Duallock™ fasteners, which are commercially available from 3M located in St. Paul, Minn.

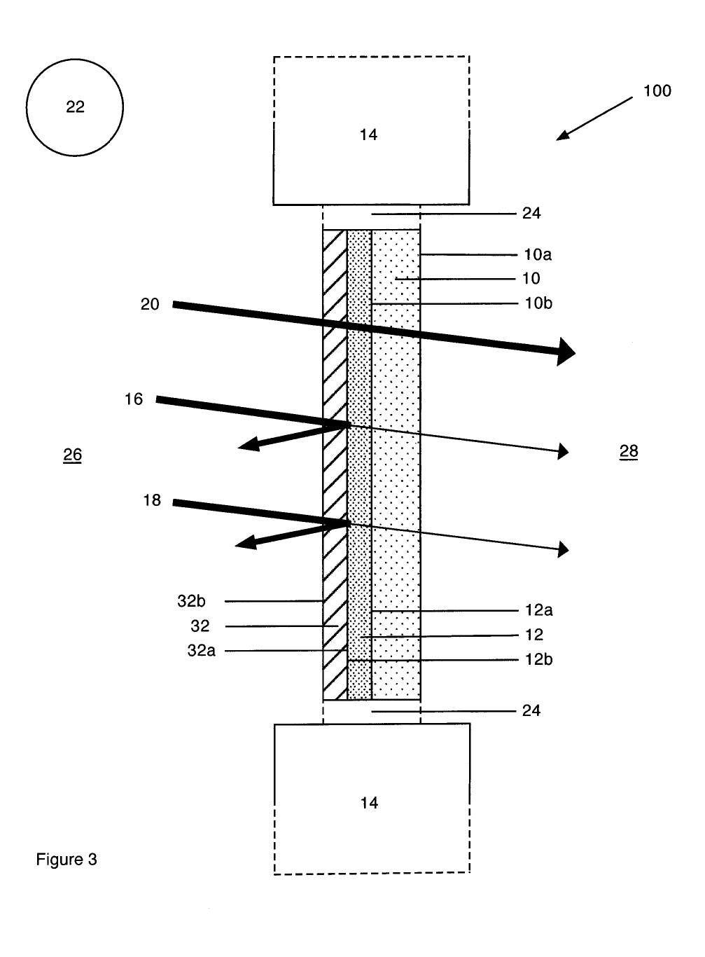

Referring now to FIG. 3, energy conservation assembly 100 may also include protective topcoat 32 having inner surface 32a and outer surface 32b. In one embodiment inner surface 32a of protective topcoat 32 is applied to outer surface 12b of energy conservation layer 12. Protective topcoat 32 reduces degradation of energy conservation layer 12 by, among other things, precluding cracks, scathes, delamination, etcetera, which is typically associated with being the outer most layer in an environment. For purposes of the present disclosure, protective topcoat 32 preferably comprises glass, natural and/or synthetic polymeric resins, plastics, and/or composites including polyesters (e.g., PET), polyimides (PI), cellular polycarbonates, polycarbonates, polysulfones, polyethylene naphthalate (PEN), ethylene vinyl acetate (EVA), and acrylate polymers.

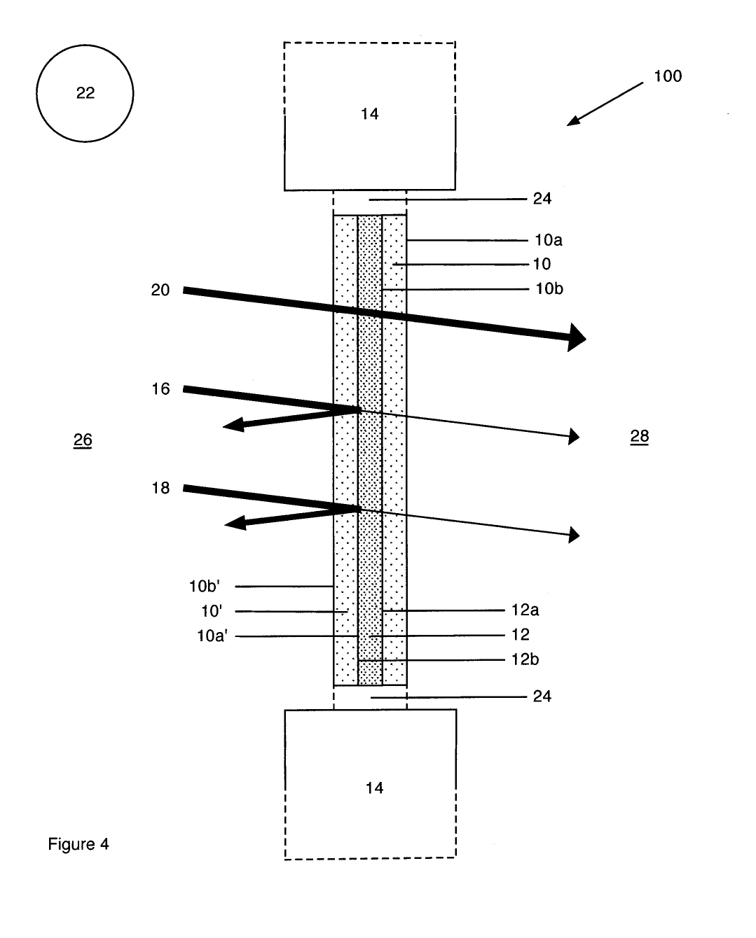

As is best shown in FIG. 4, energy conservation layer 12 may also be positioned in a sandwich configuration between first and second substrates 10 and 10′. It will be understood that second substrate 10′ may be fabricated from the same or different materials as first substrate 10. In one embodiment inner surface 12a of energy conservation layer 12 contacts outer surface 10b of first substrate 10 and outer surface 12b of energy conservation layer 12 contacts inner surface 10a′ of second substrate 10′.

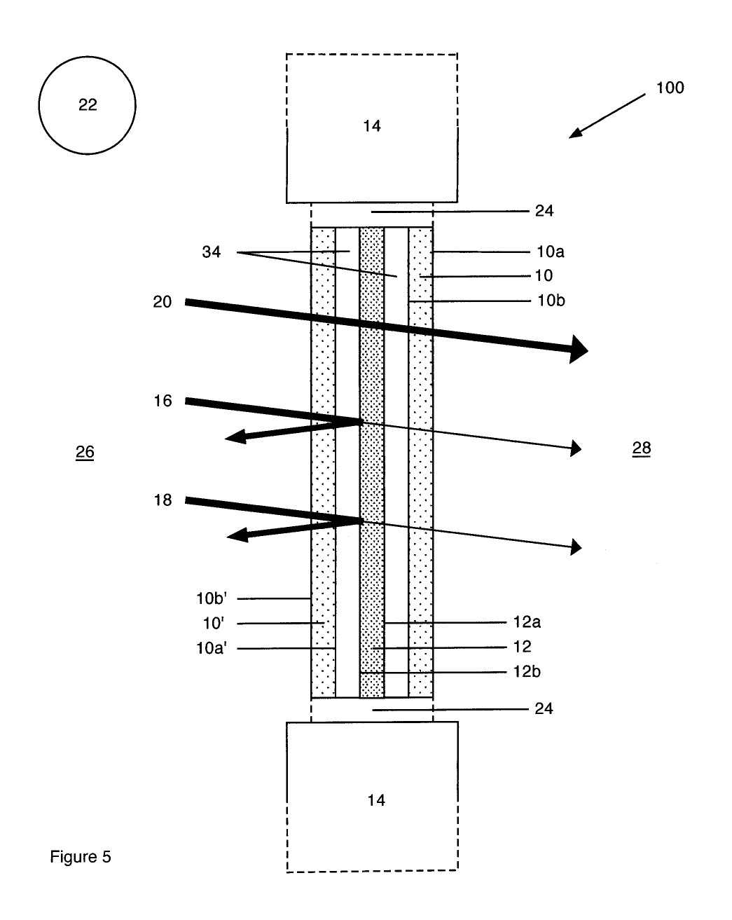

Referring now to FIG. 5, energy conservation layer 12 may also be positioned between first and second substrates 10 and 10′ which are spaced apart with insulating cells 34. Preferably, insulating cells 34 comprise a vacuum. Alternatively, insulating cells 34 may be filled with nitrogen and/or a noble gas.

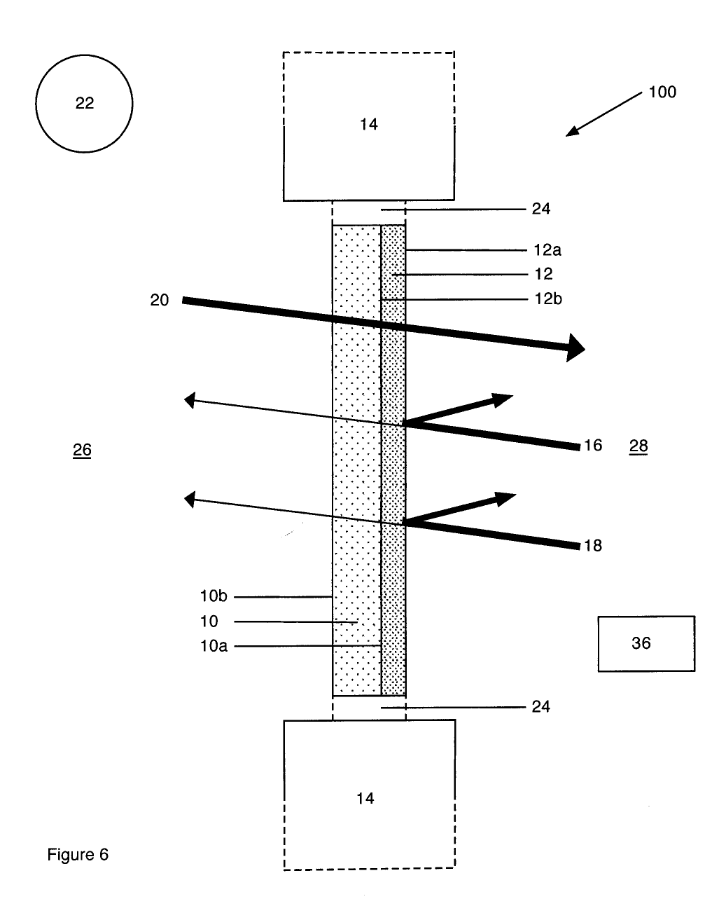

As is best shown in FIG. 6, the present invention is also directed to energy conservation assembly 100 for use in residential, commercial and/or industrial buildings, which reduce the heating load of the same. In this embodiment, energy conservation layer 12 substantially reflects any infrared radiation 16 and/or ultraviolet radiation 18 generated by heat source 36 (e.g., furnace, etcetera) back into building 14, thereby reducing the heating load of building 14. Notably, energy conservation layer 12 still permits substantial transmission of visible radiation 20 into the building so that additional energy is not utilized to light inside region 28 of building 14 due to energy conservation assembly 100.

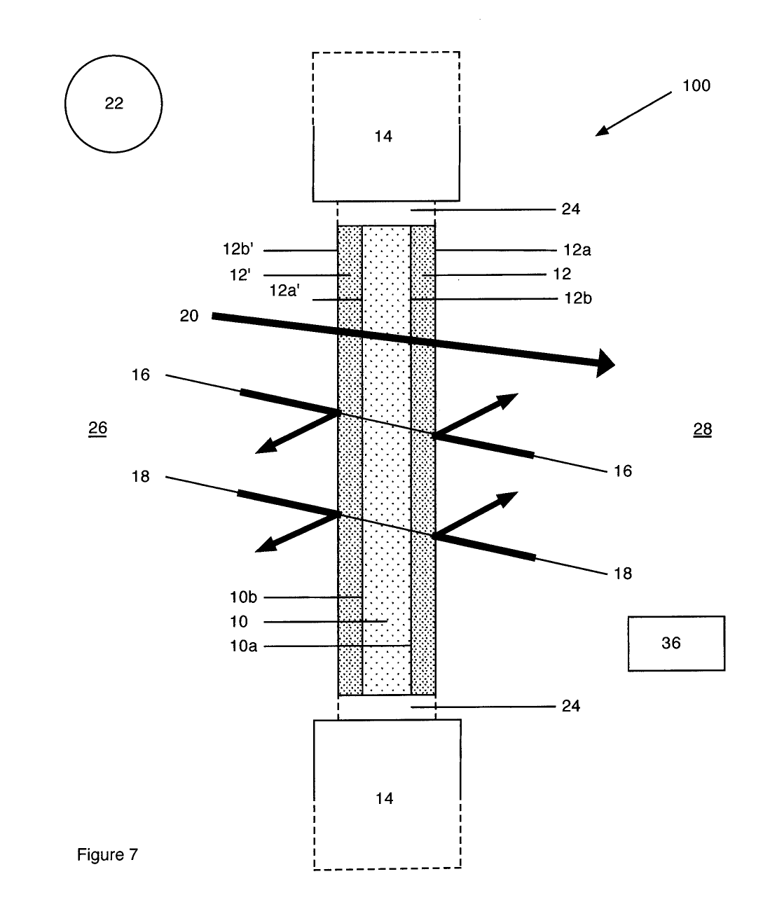

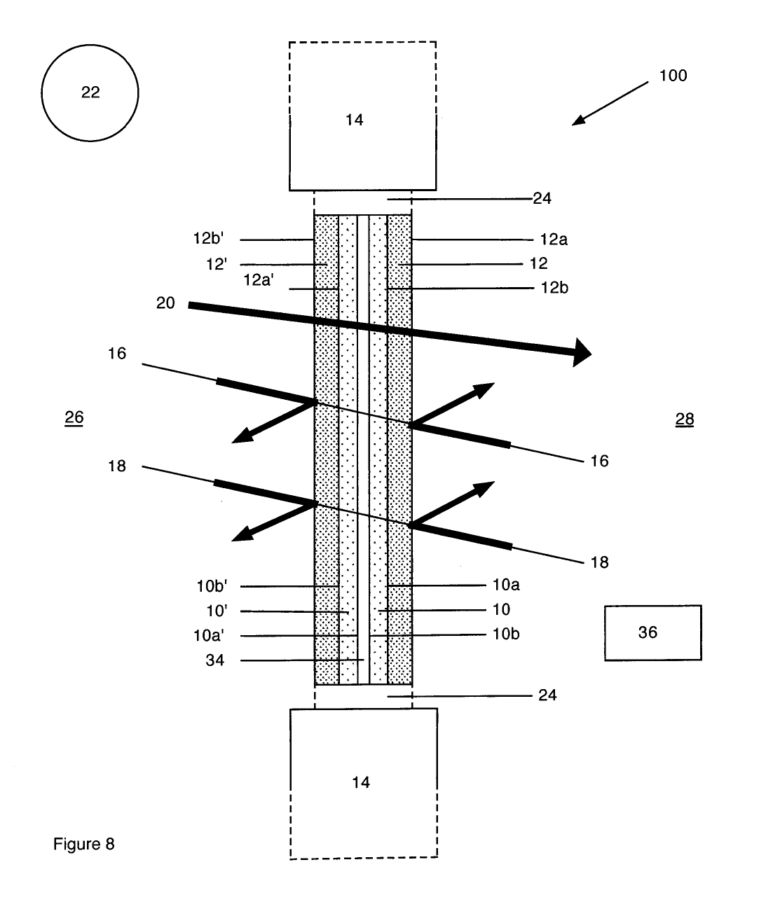

Referring now to FIGS. 7 and 8, the present invention is also directed to energy conservation assemblies 100 for use in residential, commercial and/or industrial buildings 14 which have a plurality of energy conservation layer 12 (e.g., 12, 12′). In this embodiment, energy conservation layer 12′ substantially reflects any infrared radiation 16 and/or ultraviolet radiation 18 generated by sun 22 away from building 14, and energy conservation layer 12 substantially reflects any infrared radiation 16 and/or ultraviolet radiation 18 generated by heat source 36 back into building 14. Notably, energy conservation layers 12 and 12′ still permit substantial transmission of visible radiation 20 into the building so that additional energy is not utilized to light inside region 28 of building 14 due to energy conservation assembly 100.

It will be understood that, unless otherwise specified, the chemical reagents and compounds provided herein below, or their precursors, are available from common commercial chemical vendors, such as Sigma-Aldrich Chemical Co., of St. Louis, Mo.

The invention is further described by the following examples.

### Example 1

To demonstrate the invention, four energy conservation assemblies were prepared in the shape of a conventional building window (i.e., approximately 3 feet high and 3 feet wide) by placing single and double pane golden glass (50-40, 25-20, 40-30, and 20-15) having a 3 mm acrylic 3S Solar Block layer applied to outer surfaces of the window. Transmission and reflectance data was obtained via spectrophotometry, the results of which are provided below in Table I.

TABLE I

| | | | Total Solar | | | |
|---|---|---|---|---|---|---|
| | | V Light | Energy | IR | V | UV |
| Exp. | Experimental | Transmitted | Rejected | Rejected | Rejected | Rejected |
| No. | Parameters | (%) | (%) | (%) | (%) | (%) |
| 1 | Single 50-40 | 44 | 57 | 87 | 21 | 99.9 |
| 2 | Double 25-20 | 23 | 77 | 91 | 25 | 99.9 |
| 3 | Single 40-30 | 42 | 62 | 83 | 20 | 99.9 |
| 4 | Double 20-15 | 20 | 82 | 92 | 22 | 99.9 |

While the invention has been described in detail herein in accordance with certain preferred embodiments thereof, many modifications and changes therein may be effected by those skilled in the art. Accordingly, it is our intent to be limited only by the scope of the appending claims and not by way of details and instrumentalities describing the embodiments shown herein.

What is claimed and desired to be secured by Letters Patent of the United States is:

1. An energy conservation assembly for use in a residential, commercial and/or industrial building, comprising:
a first substantially transparent substrate having an inner surface and an outer surface, wherein the first substantially transparent substrate is associated with the building;
an energy conservation layer having an inner surface and an outer surface, wherein the energy conservation layer is associated with the first substantially transparent substrate;
wherein the energy conservation layer substantially reflects both infrared and ultraviolet radiation away from the building thereby reducing cooling load of the building; and
wherein the energy conservation layer permits substantial transmission of visible radiation into the building.

2. The energy conservation assembly according to claim 1, wherein the energy conservation layer reflects at least approximately 75 percent of ultraviolet radiation emanating from the sun away from the building.

3. The energy conservation assembly according to claim 1, wherein the energy conservation layer reflects at least approximately 95 percent of ultraviolet radiation emanating from the sun away from the building.

4. The energy conservation assembly according to claim 1, wherein the energy conservation layer reflects at least approximately 99 percent of ultraviolet radiation emanating from the sun away from the building.

5. The energy conservation assembly according to claim 1, wherein the energy conservation layer reflects at least approximately 75 percent of infrared radiation emanating from the sun away from the building.

6. The energy conservation assembly according to claim 1, wherein the energy conservation layer reflects at least approximately 80 percent of infrared radiation emanating from the sun away from the building.

7. The energy conservation assembly according to claim 1, wherein the energy conservation layer reflects at least approximately 90 percent of infrared radiation emanating from the sun away from the building.

8. The energy conservation assembly according to claim 1, wherein the energy conservation layer permits transmission of at least approximately 20 percent of visible radiation into the building.

9. The energy conservation assembly according to claim 1, wherein the energy conservation layer permits transmission of at least approximately 30 percent of visible radiation into the building.

10. The energy conservation assembly according to claim 1, wherein the energy conservation layer permits transmission of at least approximately 40 percent of visible radiation into the building.

11. The energy conservation assembly according to claim 1, wherein the energy conservation layer reflects less than approximately 30 percent of visible radiation emanating from the sun away from the building.

12. The energy conservation assembly according to claim 1, wherein the energy conservation layer reflects less than approximately 20 percent of visible radiation emanating from the sun away from the building.

13. The energy conservation assembly according to claim 1, further comprising a protective topcoat layer associated with the energy conservation layer.

14. The energy conservation assembly according to claim 1, wherein the energy conservation layer is positioned on at least a portion of the outer surface of the first substantially transparent substrate.

15. The energy conservation assembly according to claim 14, wherein the protective topcoat is positioned on at least a portion of the outer surface of the energy conservation layer.

16. An energy conservation assembly for use in a residential, commercial and/or industrial building, comprising:
a first substantially transparent substrate having an inner surface and an outer surface, wherein the first substantially transparent substrate is associated with the building;
an energy conservation layer having an inner surface and an outer surface, wherein the energy conservation layer is associated with inner surface of the first substantially transparent substrate;
wherein the energy conservation layer substantially reflects both infrared and ultraviolet radiation into the building thereby reducing heating load of the building; and
wherein the energy conservation layer permits substantial transmission of visible radiation into the building.

17. An energy conservation assembly for use in a residential, commercial and/or industrial building, consisting of:
a first substantially transparent window having an inner surface and an outer surface, wherein the first substantially transparent window is associated with the building;
an energy conservation layer having an inner surface and an outer surface, wherein the inner surface of the energy conservation layer is positioned on the inner surface of the first substantially transparent window substrate;
wherein the energy conservation layer substantially reflects both infrared and ultraviolet radiation away from the building thereby reducing cooling load of the building; and
wherein the energy conservation layer permits substantial transmission of visible radiation into the building.

18. The energy conservation assembly according to claim 17, wherein the energy conservation layer reflects at least approximately 99 percent of ultraviolet radiation emanating from the sun away from the building.

19. The energy conservation assembly according to claim 17, wherein the energy conservation layer reflects at least approximately 90 percent of infrared radiation emanating from the sun away from the building.

20. The energy conservation assembly according to claim 17, wherein the energy conservation layer reflects less than approximately 20 percent of visible radiation emanating from the sun away from the building.
